(19) United States
(12) Patent Application Publication
(10) Pub. No.: US 2020/0351286 A1
(43) Pub. Date: Nov. 5, 2020

(54) CONFIGURING AN ISLAND VIRTUAL SWITCH FOR PROVISIONING OF NETWORK SECURITY SERVICES

(71) Applicant: ShieldX Networks, Inc., San Jose, CA (US)

(72) Inventors: Ratinder Paul Singh Ahuja, Saratoga, CA (US); Manuel Nedbal, Santa Clara, CA (US); Meni Hillel, San Jose, CA (US)

(21) Appl. No.: 16/403,295

(22) Filed: May 3, 2019

(51) Int. Cl. H04L 29/06; H04L 12/931; H04L 12/26; H04L 12/24; G06F 9/455

(52) U.S. Cl. CPC H04L 63/1425; H04L 49/70; H04L 43/028; H04L 69/16; G06F 2009/45595; G06F 9/45558; H04L 63/20; H04L 63/0227; H04L 41/0806

(57) ABSTRACT

Systems, methods, and apparatuses enable a security microservice to provision security services to a resource (e.g., a virtual machine) by assigning the virtual machine to an island virtual switch. An island virtual switch is a virtual switch that does not have a direct connection to a physical link, and instead interfaces with a network traffic interceptor having a connection to a virtual switch with a connection to a physical link, to direct network traffic to and form the assigned virtual machine. The network traffic interceptor performs intercept operations on at least a portion of network traffic between the virtual switch and the island virtual switch associated with the virtual machine in order to perform security operations of the portion of network traffic.

### TECHNICAL FIELD

Embodiments described herein generally relate to network security. Embodiments described herein generally relate to systems and methods for configuring an island virtual switch for provisioning of network security services.

### BACKGROUND INFORMATION

Most businesses and organizations rely on computer systems and networks for an increasingly wide variety of business operations. As reliance on computing technologies has grown, so too has the importance of securing computer systems and networks against internal and external security threats. However, the breadth and complexity of security threats targeting such computer systems and networks is far and wide and ever growing. To monitor and address these security threats, organizations increasingly rely on sophisticated computer security applications and hardware such as firewalls, anti-virus tools, data loss prevention (DLP) software, etc.

### BRIEF DESCRIPTION OF THE DRAWINGS

The various advantages of the embodiments disclosed herein will become apparent to one skilled in the art by reading the following specification and appended claims, and by referencing the drawings, in which:

FIG. 1 is a block diagram of a network security system illustrating computer hardware, including a memory and processor, in accordance with the disclosed embodiments;

FIG. 2 illustrates a scalable security architecture implementing a three-time scale out using security microservices in accordance with the disclosed embodiments;

FIG. 3 illustrates an arbitrary scaling out of a microservice in accordance with the disclosed embodiments;

FIG. 4 is a block diagram illustrating a security service configured to monitor traffic sent among an application and one or more servers through a routing network in accordance with the disclosed embodiments;

FIG. 5 is a block flow diagram illustrating application data traversing to a server after passing through a hierarchy of security microservices in accordance with the disclosed embodiments;

FIG. 6 is a flow of application data through a stateless processing, fault-tolerant microservice environment in accordance with the disclosed embodiments;

FIG. 7 is a block diagram illustrating an example computing device running at least one virtual machine coupled to a routed network via a virtual switch in accordance with the disclosed embodiments;

FIG. 8 is a block diagram illustrating an example computing device including an interface microservice configured to intercept network traffic routed through a virtual switch in accordance with the disclosed embodiments;

FIG. 9 is a block diagram illustrating an interface microservice configured to intercept network traffic associated with an island virtual switch in accordance with disclosed embodiments;

FIG. 10 is a flow diagram illustrating a process for creating an island virtual switch for a virtual machine requiring security services in accordance with an embodiment;

FIG. 11 is a flow diagram illustrating a process for performing security processing on network traffic between a virtual switch and an island virtual switch in accordance with an embodiment; and

FIG. 12 is a block diagram that illustrates a computer system utilized in implementing the above-described techniques in accordance with some of the disclosed embodiments.

### DETAILED DESCRIPTION

In the following description, numerous specific details are set forth. However, it is understood that embodiments of the disclosure may be practiced without these specific details. In other instances, well-known circuits, structures and techniques have not been shown in detail to not obscure the understanding of this description.

References in the specification to “one embodiment,” “an embodiment,” “an example embodiment,” etc., indicate that the embodiment described may include a particular feature, structure, or characteristic, but every embodiment need not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Environments that include virtual machines may further include one or more virtual switches (also referred to herein as a “vSwitch”), where a vSwitch manages network traffic for some number of virtual machines connected to virtualized ports of the vSwitch to form one or more virtual local area networks (“VLANs”). The configuration of a vSwitch can also include port groups, where a port group is a logical grouping of vSwitch ports (and by extension the VMs connected to those ports). Furthermore, port groups of a vSwitch can be assigned a trunk, where a trunk merges a group of virtual network links into a single logical link and can enable VLANs to span across different vSwitches.

In order to dynamically apply security processing to network traffic for virtual machines, a security system utilizing a plurality of microservices can be implemented. In conventional systems, reserved VLANs, IP addresses, or similar exhaustible and potentially conflicting resources must be provisioned and maintained to allow dynamic insertion and application of security processing. For example, intercept VLANs can be created to intercept network traffic directed to an original VLAN. However, this requires creating an increasingly larger number of intercept VLANs as the number of original VLANs increases, which can consume significant computing and networking resources. In addition, a systems administrator must also take precautions to reserve those intercept VLANs in perpetuity to prevent their use in some other portion of the switching infrastructure and thereby cause cross-contamination between secure and insecure portions of the environment.

To address the deficiencies of existing security infrastructures, embodiments detailed herein describe utilizing a virtual switch that does not have a direct access or connection to a physical link to an external network to handle network traffic for a resource (e.g., a virtual machine) designated for security processing. Without direct access to a physical link to an external network, the island virtual switch instead receives network traffic directed to a virtual machine assigned to the island virtual switch from another virtual switch (e.g., one with a connection to a physical link) via a network traffic interceptor. In some embodiments, the resource can be either a previously created resource currently associated with another virtual switch, or the resource can be newly created without having been assigned to a virtual switch.

For example, some embodiments detailed herein utilize a security service to identify a resource (e.g., a virtual machine) requiring security services. Where the virtual machine is a preexisting virtual machine, the virtual machine may have been assigned to a first virtual switch having a connection to a physical link. The security service creates or deploys an island virtual switch and assigns (or re-assigns) the virtual machine to the island virtual switch for handling network traffic associated with the virtual machine. The security service creates a network traffic interceptor (e.g., on an interface microservice) with one interface to the first virtual switch and another interface to the island virtual switch. The network traffic interceptor allows network traffic to flow to and from the virtual machine assigned to the island virtual switch, e.g., from other resources on the island virtual switch, other virtual switches, and/or from a network. The security service configures the network traffic interceptor to intercept network traffic associated with the virtual machine and perform security processing on at least a portion of the network traffic based on properties of the network traffic and security policies associated with the properties.

Using an island virtual switch and a network traffic interceptor on an interface microservice to intercept and route network traffic addresses the problems created in environments using intercept VLANs. For example, this solution does not require provisioning an intercept VLAN for each corresponding original VLAN to provide security services for on network traffic directed to original VLANs. Further, utilizing an island virtual switch ensures that network traffic associated with original VLANs operating within the island environment will not leak into the pre-existing environment except as processed and verified by the security service.

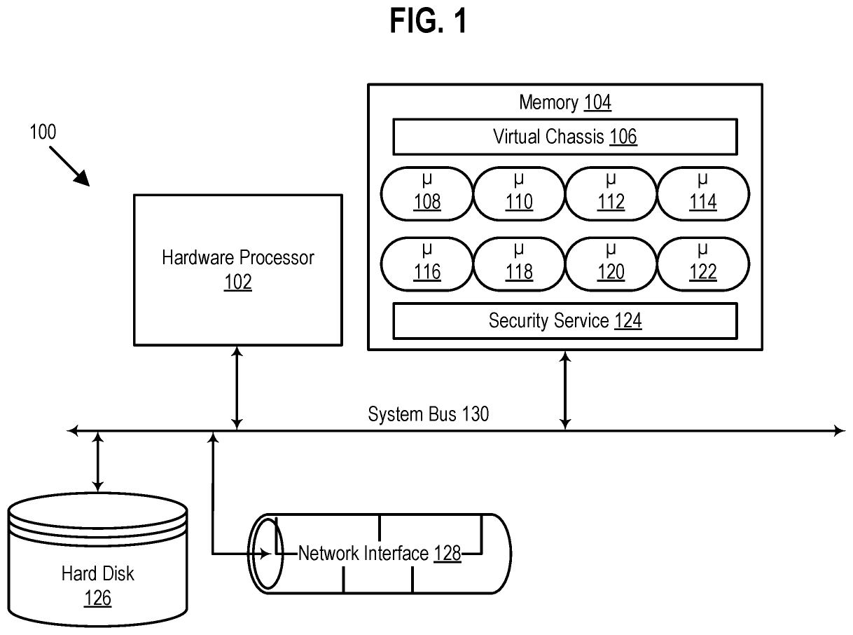

FIG. 1 is a block diagram of network security system 100 illustrating computer hardware, including a memory (e.g., 104) and processor (e.g., 102), in accordance with the disclosed embodiments. Network security system 100 further includes a hard disk (e.g., 126) and network interface (e.g., 128). In one embodiment, hardware processor 102, memory 104, hard disk 126, and network interface 128 are coupled to each other via a system bus (e.g., 130). Network security microservices 108-122 are stored in memory 104 (e.g., volatile memory such as Random-Access Memory (RAM) and/or non-volatile memory such as solid-state storage or disk) and executed by one or more processor cores or hardware processor 102. Network security microservices 108-122, consisting of computer-executable instructions to perform one or more specific security services, are deployed based on configuration across available physical servers. Typically, each microservice receives a configuration and tasks via a backplane of a virtual chassis 106, and returns status, statistics, and other information to the backplane.

The data processed by the network security system 100 is transferred from a microservice to another (higher hierarchy) microservice using a data plane. In some embodiments, during such a transfer, a lower hierarchy microservice decides (based on configuration, current statistics, and other information) as to which next microservice to utilize. Such a decision may constitute a load-balancing decision to assure that the higher hierarchy microservices are efficiently utilized. In other embodiments, the decision of which microservice to utilize is made by a more central entity.

As illustrated, network security system 100 utilizes hardware processor 102 (such as a central processing unit (CPU) or one or more cores thereof, a graphics processing unit (GPU) or one or more cores thereof, or an accelerated processing unit (APU) or one or more cores thereof) to execute microservices and other applications (e.g., virtual chassis 106, security service 124, etc.) stored in memory 104. Network interface 128 (e.g., fabric or interconnect that is wired or wireless) provides a means for communicating with a data center. Network security system 100 may inspect traffic, detect threats, generate security settings and policies (e.g., access control lists), and otherwise protect a data center using the microservices 108-122.

Embodiments of network security system 100 providing the above capabilities are now discussed in more detail. Network security system 100 adds security to, or enhances the security of, a datacenter or other computing environment. In one embodiment, network security system 100 is delivered (e.g., downloaded) in the form of a seed software application. The seed software application instantiates microservices of the network security system on a host in the datacenter. As used herein, a microservice container refers to where the microservice runs, for example, on a virtual machine. Once deployed, network security system 100 utilizes a hardware processor 102, memory 104, and network interface 128. In many scenarios, security can be added/configured using existing hardware and/or without purchasing additional rack devices for particular functionality. The seed software application may be installed on any one of a wide variety of hosts—be they slow or fast, low-cost or high-cost, commodity or customized, geographically dispersed, part of a redundancy scheme, or part of a system with regular back-ups.

In some embodiments, network security system 100 utilizes a network interface 128 to explore the datacenter and to discover existing network segments, determine security settings and policies to apply to various network segments, detect available hosts and hardware resources, and determine additional configuration information as needed. In one embodiment, the datacenter itself includes several machines with hypervisors, or physical hardware, and the network security system 100 offers microservices to communicate with and protect one or more of those internal virtual machines or physical hardware. Based on performing datacenter discovery, network security system 100, in some embodiments, may then offer or suggest available security tools for selection either through a graphical interface or via connections with existing enterprise management software. In one embodiment, once configured, network security system 100 is deployed “in-line,” receiving packets headed for the datacenter, thereby allowing network security system 100 to intercept and block suspicious traffic before it reaches the datacenter. With an understanding of the datacenter, network security system 100 deploys microservices to inspect traffic throughout the datacenter, and not only at ingress. In some embodiments, network security system 100 is deployed in a “copy only” configuration, in which the system monitors traffic, detects threats, and generates alerts, but does not intercept traffic before it arrives at the datacenter.

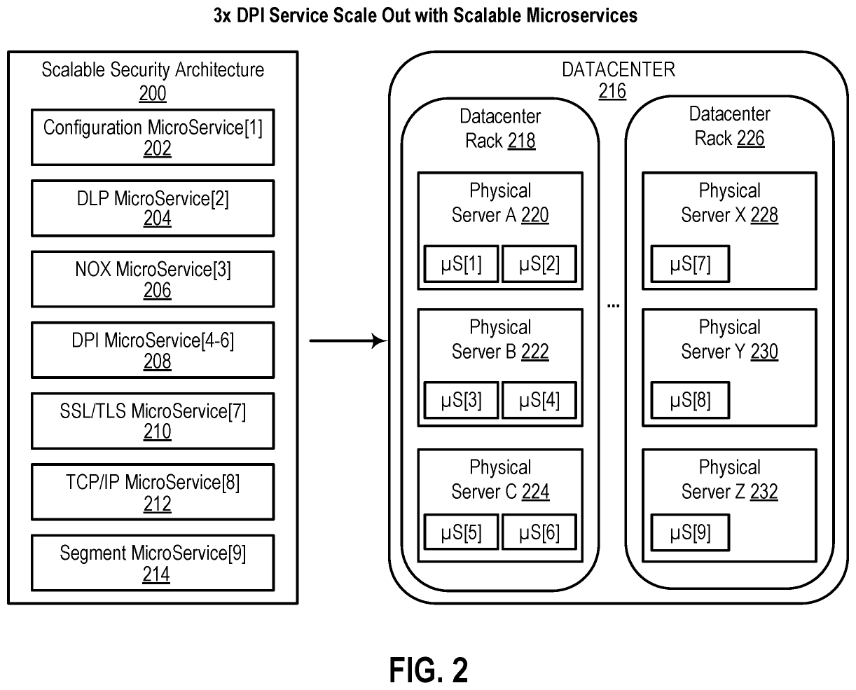

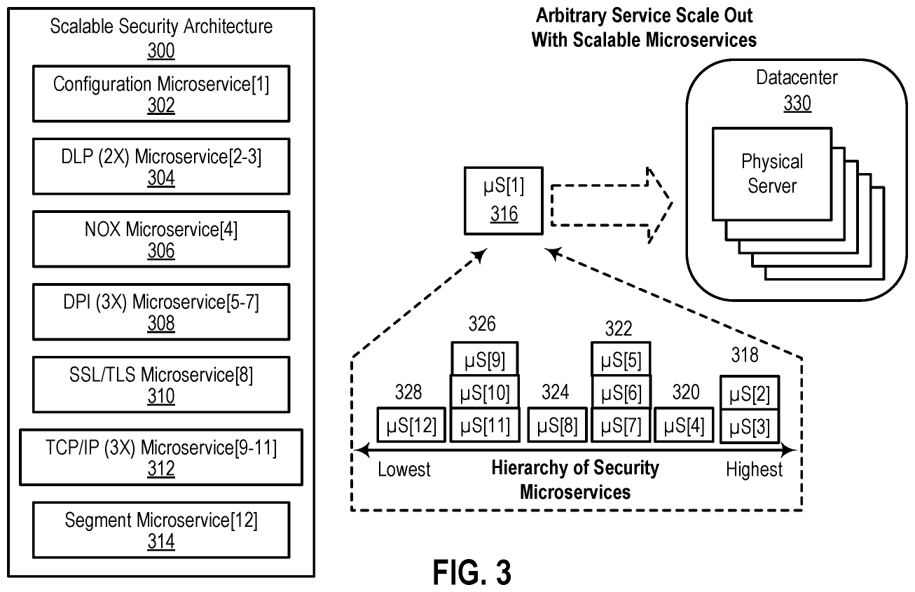

As shown, memory 104 has stored therein microservices 108, 110, 112, 114, 116, 118, 120, and 122 (108-122), as well as a virtual chassis 106, which may also be a microservice. In one embodiment, the microservices are small in size, consisting of a relatively small number of instructions. In one embodiment, the microservices 108-122 are independent of each other. As illustrated, microservices 108-122 are microservices that are loaded from memory and executed by the hardware processor 102. Those microservices 108-122 include data path security microservices, for example TCP/IP, SSL, DPI, or DLP microservices, as described further below with respect to FIGS. 2 and 3. The microservices 108-122 may also include management microservices, for example, a chassis controller to manage the microservices, a configuration microservice, an infrastructure discovery microservice, a database microservice to store data, a policy update microservice to receive policy updates from an external security cloud, and a compiler to receive policy data from various sources and to produce binary policy outputs to be used by the microservices, to name a few examples that are described hereinafter with respect to FIGS. 2 and 3.

Memory 104 also stores security service 124. Security service 124 is configured to manage the initialization and configuration of one or more of a plurality of microservices. For example, security service 124 is configured to initialize and configure an interface microservice as a trunk between virtual switches to allow network traffic (e.g., packets) to be sent to and from an island virtual switch and the resources (e.g., VMs) assigned to the island virtual switch. Security serviced 124 also configures interface microservices to perform security processing on the network traffic to prevent potentially bad or malicious network traffic from being transmitted to and/or from resources. The processes disclosed herein can be performed by security service 124 or by microservices (e.g., microservices 108-122) based on instructions from security service 124.

It will be understood by those of ordinary skill in the art that a datacenter typically employs many instances of the hardware represented within network security system 100 such as hardware processor 102 and memory 104. Individual servers may have multiple processors or multiple processing boards each with multiple processors. Processors may have a plurality of processing cores and access a plurality of network interfaces. Security service 124 comprises program code executing within a processor and may have interfaces (such as configuration or administration user interfaces) that are made available over a network to users. In a virtualized environment, the user may not be aware of the specific processor on which security service 124 is executing and, in some embodiments, that processor may change based on loading of the virtual environment. Such changes may occur based on administrator requests or automatically based on the virtual environment's control software.

In one embodiment, network security system 100 receives traffic via network interface 128 to/from a datacenter. In one embodiment, network security system 100 is placed in-line to inspect traffic, and potentially intercept a threat before it arrives at, or leaves, the datacenter. In other embodiments, network security system 100 monitors the traffic heading into, or out of, the datacenter, in which case network security system 100 detects threats and generates alerts but does not block the data. Hardware processor 102 may execute various data security microservices on the data. For example, as described hereinafter with respect to FIGS. 2 and 3, typically traffic first passes into and through a segment microservice, then a TCP/IP inspection microservice, then an SSL microservice, then a DPI microservice, then a NOX microservice, and then a DLP microservice. However, one or more of these services may not be enabled. In some embodiments, a segment microservice resides within a network segment and serves as the entry point for packets and forwards the packets to appropriate microservices for further analysis. Data path microservices as used herein refer to various microservices that inspect and analyze network traffic, such as TCP, TLS, DPI, NOX, and DLP microservices. A TCP microservice, for example, refers to a packet handling microservice able to process any layer 4-6 network packet and includes part of firewalling. A TLS microservice, for example, refers to a Transport Layer Security microservice, which decrypts/re-encrypts connections. A DPI microservice, for example, refers to a Deep Packet Inspection microservice and handles layer 7 inspection. A NOX microservice, for example, refers to a Network Object Extractor microservice, and works in conjunction with DPI to assemble objects from individual packets and to deliver the objects to other services. A DLP microservice, for example, refers to a Data Loss Prevention microservice, which detects and attempts to prevent data loss. Control path microservices, on the other hand, are various microservices, such as a factory, a compiler, a configuration, an infrastructure discovery, a database, a messenger, a scaler, and a chassis controller, that are instantiated in, and make up, a management plane. Threats detected by the aforementioned microservices, in one embodiment, are reported to a chassis controller microservice, which takes remedial action.

In one embodiment, microservices 108-122 are implemented using computer-executable instructions loaded from the Internet via network interface 128. For instance, in one embodiment, the microservices are implemented with computer-executable instructions downloaded from a web site or online store site. In some embodiments, microservices 108-122 are loaded into memory 104. In various embodiments, the microservices are implemented using computer-executable instructions loaded on and received from a non-transitory computer-readable medium, such as digital media, including another disc drive, a CD, a CDROM, a DVD, a USB flash drives, a Flash memory, a Secure Digital (SD) memory card, a memory card, without limitation. Microservices received from a digital medium may be stored into memory 104. The embodiments are not limited in this context. In further embodiments, a digital medium is a data source that constitutes a combination of hardware elements such as a processor and memory.

In most embodiments, network security system 100 runs on a datacenter computer. In other embodiments, however, network security system 100 is installed and runs on any one of a wide variety of computing platforms, ranging from low-cost to high-cost, and from low-power to high power. In some embodiments, network security system 100 runs on a server. In some embodiments, network security system 100 is installed on and runs on a low-cost, commodity server computer, or on a low-cost rack-mounted server. As illustrated, hardware processor 102 is a single core processor. In alternate embodiments, hardware processor 102 is a multi-core processor. In alternate embodiments, hardware processor 102 is a massively parallel processor. In some embodiments, a virtual chassis 106 and microservices 108-122 may be hosted on any of a wide variety of hardware platforms used in the datacenter to be protected.

In some embodiments, network security system 100 scales out using available resources to accommodate higher traffic or load. In one embodiment, hardware processor 102 (CPU) and memory 104 are scaled out or in dynamically as needed: additional CPUs and memory are added if scaling out, and some CPUs and/or memory are powered down if scaling in. This scaling out is performed to allocate the additional CPUs and memory to those portions of the security hierarchy for which there is demand, while not allocating additional CPUs and memory to those portions of the security hierarchy that can accommodate the higher traffic utilizing their existing allocation.

One property of a microservice is the separation and protection of memory from other microservices. In this manner, an individual microservice may be moved to another physical server or terminate abnormally without impacting other microservices. Microservices may be distinguished from threads in that threads generally operate within a shared memory space and exist within the confines of an operating system on which the microservices were spawned.

FIG. 2 illustrates an example scalable security architecture implementing a three-time scale out using security microservices. In the example of FIG. 2, only a single microservice (e.g., a DPI microservice) has a demand for additional resources. As shown, by utilizing a scalable microservice architecture 200, including DLP microservice 204, NOX microservice 206, DPI microservice 208, SSL/TLS microservice 210, TCP/IP microservice 212, and segment microservice 214, each level of the security service hierarchy can be scaled and configured independently to load balance the supply of processed data to the next hierarchy level. As shown, datacenter 216 includes datacenter rack 218, which includes physical server A 220, physical server B 222, and physical server C 224. As shown, a datacenter rack 226 includes physical server X 228, physical server Y 230, and physical server Z 232. DPI microservices 208 have been scaled out 3×, and in this instance assigned to be performed as microservices 4-to-6 on physical server B 222 and physical server C 224. The remaining microservices of scalable security architecture are shown as being implemented by physical servers A, X, Y, and Z (220, 228, 230, and 232, respectively). A configuration microservice 202 creates a configuration backplane and a data plane deployed as a software component on each physical server that is to receive security services. This process includes configuring routing rules, reserving network address space (such as a subnet), and configuring virtual environments to utilize portions of the reserved address space as gateways for network communication in and out of the servers to be secured. Both the backplane and data plane may thus be considered virtual networks managed by the security system. Security microservices may then utilize these networks to transmit packets, content, state, and other information among the microservices. The properties of the backplane and data plane are configured to reject packet traffic from outside the security system and to route information between microservices regardless of the physical server and virtual environment configuration.

FIG. 3 illustrates an arbitrary scaling out of a microservice according to an embodiment. As shown, scalable security architecture 300 includes configuration microservice 302, DLP (2X) microservice 304 (a 2-times scale-out), NOX microservice 306, DPI (3×) microservice 308 (a 3-times scale-out), SSL/TLS microservice 310, TCP/IP (3×) microservice 312 (a 3-times scale-out), and segment microservice 314. As shown, configuration microservice 316 provisions (318, 320, 322, 324, 326, and 328) the 11 microservices from a lowest hierarchy to a highest hierarchy and configures them to communicate with each other via a backplane. The microservices, for example, may be implemented by physical servers in datacenter 330.

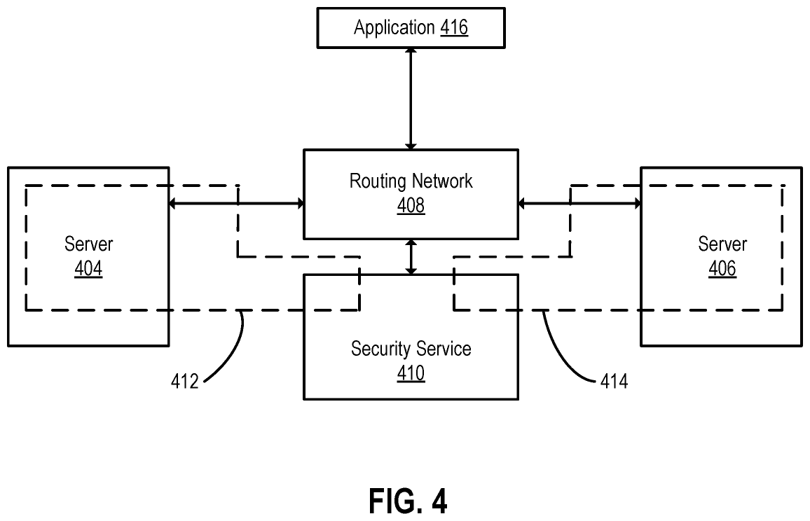

FIG. 4 is a block diagram illustrating a networked computing environment in which an embodiment may be implemented. FIG. 4 represents an example embodiment that is provided for purposes of illustrating a clear example; other embodiments may use different arrangements.

The networked computer system depicted in FIG. 4 comprises one or more computing devices. These one or more computing devices comprise any combination of hardware and software configured to implement the various logical components described herein. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

In one embodiment, one or more security services 410 may be configured to monitor network traffic and other data sent between application 416 and one or more servers 404 and 406 through a routing network 408. In one embodiment, security service 410 is an example of security service 124 in FIG. 1. In one embodiment, security service 410 comprises one or more “microservices” (e.g., microservices 108-122 in FIG. 1) used to monitor and perform various actions relative to data items (e.g. network traffic, files, email messages, etc.) sent to and received from one or more applications 416 and servers 404 and 406. The microservices comprising security service 410 do not need to be confined to one physical server such as a server 404 and 406. For example, one or more microservices of the security service 410 may be executed on server 404 and other microservices of the security service 410 are executed on 406. In some embodiments, the security service 410 is executed on a different server from one or more servers for which the security service is responsible for monitoring and protecting. In one embodiment, servers 404 and 406, security service 410, and application 416 are deployed in a networked environment. Examples of networked environments include data centers, an on-premise stack, and a set of servers remotely connected using a network.

In one embodiment, a routing network 408 provides connectivity among servers 404 and 406, security service 410, and application 416. In some embodiments, routing network 408 is partially configured responsive to hypervisor configuration of servers 404 and 406. In some embodiments, a routing network 408 is partially or entirely configured responsive to hypervisor configuration of servers 404 and/or 406.

In one embodiment, based on routing information included in channel data encapsulation packets, data traveling between an application 416 and server 404 and/or server 406 is routed to the correct server, and is kept separate from data traveling between the application 416 and the other server. Accordingly, what is essentially a private network 412 may be created between the server running security service 410 and server 404. Similarly, what is essentially a private network 414 may be created between the server running security service 410 and server 406.

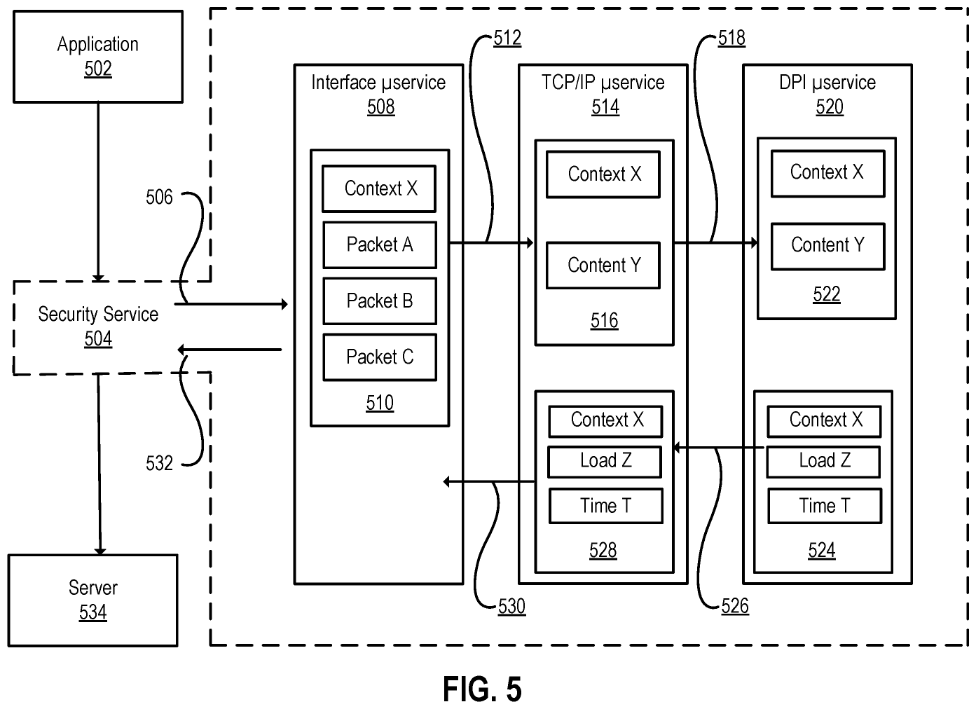

FIG. 5 is a block flow diagram illustrating application data traversing to a server after passing through a hierarchy of security microservices according to an embodiment. As illustrated, the flow begins with security service 504 receiving a network packet from application 502. In one embodiment, security service 504 is an example of security service 124 in FIG. 1. Security service 504 receives the packet (e.g., from an application or program that redirects packets to security service 504), and security service 504 forwards 506 the packet to interface microservice 508, which generates a channel data encapsulation packet 510 encapsulating three packets A, B, and C, and a context X. As shown, channel data encapsulation packet 510 encapsulates three packets, but in alternate embodiments, the number of encapsulated packets may vary without limitation. In some embodiments, context X is generated based at least on the headers of packets A, B, and C. In some embodiments, context X is generated based on a lookup of packet header fields such as IP addresses, ports, and MAC addresses for the source and destination of the packets. In some embodiments, the generation of context X includes using an interface identifier obtained from a virtualization environment. Generation of context X may be accomplished through a lookup of header fields and other data in a table, a hash of header fields and other data, or another method whereby packets for which a common security policy is to be applied are associated with a common context or common portion, such as a bit field, of the context.

Context X may be considered an identifier describing the traffic streams, source machines, or applications responsible for generating packets A, B and C. This identifier may be direct (such as an ID used as a table look up), indirect (such as a pointer used to access a data structure), or some other method of instructing microservices as to the policies and processing to use for handling packets A, B, and C. As an example, context X may be generated by performing a hash, longest prefix match, or lookup of header fields such as IP addresses, TCP ports, interface names (or MAC addresses), or other packet properties. The lookup may be an exact match, longest prefix match, or other method to associate packet streams with the same security processing to use. The generated context may then be used by security services, such as a DPI service, to determine which rules to utilize when scanning the data from packets A, B, and C (and other packets that are part of the same traffic stream). This information may be embedded within the context (as a bit field or other information), available by indirection (such as a table or data structure lookup by another service) or generated programmatically based on any combination of such information.

The context may be generated through a look up at an interface microservice and is included in the transmission of packet data to transmission control protocol (TCP) reassembly services. Reassembled content from the TCP microservice is transmitted to a deep packet inspection (DPI) microservice or secure socket layer (SSL) microservice, and with the same context. By maintaining this context in the encapsulation of data transport throughout the microservice hierarchy, processing directives associated with a context become a shared read-only resource (relative to the microservices) and may only rarely use stateful updates.

Interface microservice 508 transmits 512 the channel data encapsulation packet 510 to TCP/IP microservice 514. As shown, the channel data encapsulation packet 516 includes context X and content Y, which corresponds to packets A, B, and C of channel data encapsulation packet 510. After conducting security processing of the channel data encapsulation packet 516, TCP/IP microservice 514 transmits 518 the packet to DPI microservice 520. As shown, the channel data encapsulation packet 522 includes context X and content Y, which corresponds to packets A, B, and C of channel data encapsulation packet 510. After conducting security processing of the channel data encapsulation packet 522, DPI microservice 520 generates channel data encapsulation packet 24, which, as shown, includes context X, DPI load Z, and DPI timestamp T. Encapsulated channel data may be tagged with properties including a timestamp and a load metric. The timestamp may reference the duration of microservice processing, the time at which microservice processing started or another temporal property associated with processing the encapsulated channel data. The load metric may reference the relative or absolute loading of a microservice processing the encapsulated channel data.

As shown, a DPI microservice 520 transmits, via path 526, channel data encapsulation packet 524 to TCP/IP microservice 514, which uses the DPI load and DPI timestamp information to inform future load-balancing decisions. As shown, a TCP/IP microservice 514 generates channel data encapsulation packet 528, which includes context X, TCP/IP load Z, and TCP/IP timestamp T. As shown, TCP/IP microservice 514 transmits, via path 530, channel data encapsulation packet 528 to interface microservice 508, which uses the TCP/IP load and TCP/IP timestamp information to inform future load-balancing decisions. The flow is completed when interface microservice 508 transmits, via path 532, packets to security service 504, which transmits the packets to a server 534.

As shown, DPI microservice 520 transmits channel data encapsulation packet 524 to TCP/IP microservice 514, which uses the DPI load and DPI timestamp information to inform future load-balancing decisions. As shown, TCP/IP microservice 514 generates channel data encapsulation packet 528, which includes context X, TCP/IP load Z, and TCP/IP timestamp T. As shown, TCP/IP microservice 514 transmits channel data encapsulation packet 528 to interface microservice 508, which uses the TCP/IP load and TCP/IP timestamp information to inform future load-balancing decisions. The flow is completed when interface microservice 508 transmits, via path 532, packets to security service 504, which transmits them to server 534 microservice.

Exemplary benefits of the security service 504 may include the ability of each microservice to utilize the same channel data encapsulation protocol for all communication, thereby allowing scaling across the entirety of the datacenter network routable via the channel data encapsulation header. Communications between microservices maintain a context X generated at interface microservice 508 to all subsequent microservices that no longer have access to the original packets. As an example, a DPI microservice processing content reassembled by a TCP/IP microservice has no visibility into the packets used by the TCP/IP microservice to reassemble the content. However, the context X generated upon reception of one or more of those packets at the interface microservice, forwarded to the TCP/IP microservice and subsequently forwarded by the TCP/IP microservice to the DPI microservice, may be used to determine policy or select a minimal DPI signature set by the DPI microservice without incurring additional state processing. By providing load and timestamp data in the channel data encapsulation packets 524 and 528, which are returned via transmission paths 526 and 530, the microservices receive and can maintain real-time loading and processing latency information utilized to make load balancing decisions.

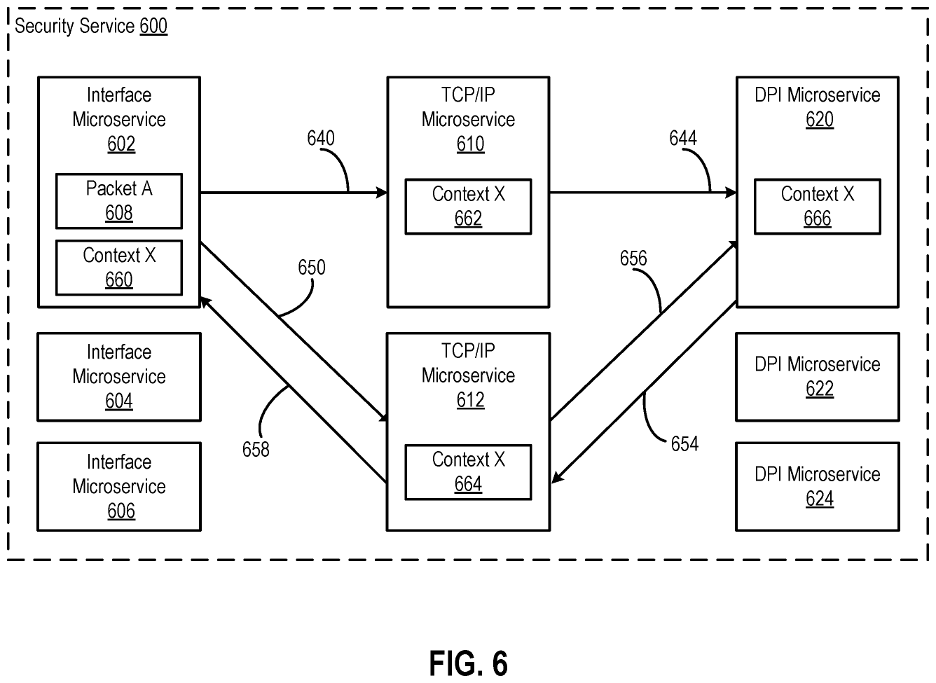

FIG. 6 is a block diagram illustrating a flow of application data through a stateless processing, fault-tolerant microservice environment in accordance with disclosed embodiments. As illustrated, security service 600 includes interface microservices 602, 604, and 606, TCP/IP microservices 610 and 612, and DPI microservices 620, 622, and 624. Other examples include a different number of microservices and/or a different number of microservice types. In one embodiment, security service 600 is an example of security service 124 in FIG. 1. In the example of FIG. 6, an interface microservice 602 receives packet A 608, and generates a context X 660.

One benefit of the security system illustrated in FIG. 6 is the handling of state. For example, if packets belong to a certain context X, the security service 600 may enable both TCP/IP microservices 610 and 612 to perform meaningful work on the packets. By implementing TCP/IP processing as microservices 610 and 612 with an external state structure and a context that accompanies processed data, each TCP/IP microservice, and any other microservice at every level of the security hierarchy, can be isolated from other microservices and can be scaled independently. Each microservice can access the state for any packet or reassembled packet data, thereby enabling real-time load balancing. In many cases, the context enables microservices to forego consulting service state (state associated with processing at the hierarchy level of the specific microservice), thereby reducing the demands on the global state repository.

As an example, consider the context X 662 obtained by TCP/IP microservice 610 as part of packets received from interface microservice 602 as transmission path 640. Context X 662, when transmitted to DPI microservice 620 as part of transmission path 644, along with the reassembled packet data, contains information that may enable the DPI microservice to forego or simplify processing of this reassembled data. Such information can include, for example, a context bit or field specifying a subset of regular expressions or patterns to be used for DPI processing, a number of bytes of reassembled data to be received before beginning DPI processing, specific allowed or disallowed protocols, and other information potentially avoiding a DPI state lookup.

In an embodiment, microservices of a security service 600 are stateless. For example, each of the microservices may retrieve state information from an outside source such that the microservice can process packets or content belonging to any context. Each microservice may retrieve and update service state (that state associated with the microservice processing). Additionally, each microservice may retrieve and update context state (state associated with the context relevant for all security service processing). In some embodiments, the process state and context state share a global state service. Examples of elements of context state include a level of suspicion regarding traffic from a source IP, a policy to ignore certain ports or protocols, and other information used to process the packets, reassembled content, and extracted objects from communication identified with the context.

In an embodiment, multiple microservices in the same or different hierarchy of the security system may be able to process packets associated with the same context at the same time. If one security microservice fails (e.g., if a TCP microservice fails to respond to a request), another microservice can take over and process the request using the failed microservice's context.

Returning to FIG. 6, the generation of context X 660 may include considering properties associated with a packet A 608 (e.g., such as an n-tuple detailing routing information), and a state lookup or a context lookup, in addition to other information. Interface microservice 602 provides packet A 608 and context X 660 to TCP/IP microservice 610 or 612 via transmission paths 640 or 650, respectively. For example, interface microservice 602 may conduct a load-balancing to select one of the TCP/IP microservices to forward the packet A 608 and the context X 660.

In an embodiment, TCP/IP microservices 610 and 612 are stateless, but may benefit from the context X generation performed by interface microservice 602. For example, whichever of TCP/IP microservices 610 and 612 receives packet A may disassemble the packet to extract the data associated with the packet and conduct security processing on the data. TCP/IP reassembly generally consists of associating packets with flows (e.g., identified by source and destination IP and port values) and using the TCP sequence numbering to place the packets into a correct order, remove any overlap or duplication, and/or identify missing or out of order packets.

In FIG. 6, TCP/IP microservices 610 or 612 forward the extracted data and/or the data resulting from the security processing to DPI microservice 620 via transmission paths 644 or 656, respectively. Along with the transmitted data, TCP/IP microservice 610 or 612 forwards context X 662 or 664, respectively, to DPI microservice 620. In some embodiments, context X 660, 662, 664, and 666 are substantially identical.

In an embodiment, DPI microservice 620 is also stateless and may use the context provided by TCP/IP microservice 610 or 612 in transmission 644 or 656. DPI microservice 620 may load DPI processing state before processing the received data, but can perform some work (e.g., scheduling different DPI pattern state tables) based on the context. Transmitting the context to the DPI microservice therefore may obviate some amount of work by the DPI microservice. If TCP/IP microservice 610 fails and interface microservice 602 instead utilizes TCP/IP microservice 612, DPI microservice 620 may obtain the context from the transmission of reassembled TCP content in transmission 656.

Although FIG. 6 does not show a second packet, when a subsequent packet associated with the same context is received, interface microservice 602 may conduct a load balancing and select one of the TCP/IP microservices to forward the packet along with context X 660. In one embodiment, interface microservice 602 chooses to forward the second packet to TCP/IP microservice 612 via transmission path 650. TCP/IP microservice 612 performs some security processing, then transmits the second packet and context X 664 to DPI microservice 620 via transmission path 656. After performing some security processing, DPI microservice 620 responds to TCP/IP microservice 612 via transmission path 654, and TCP/IP microservice responds to interface microservice 602 via transmission path 658.

Summarizing the operation of an embodiment as illustrated by FIG. 6, an interface microservice transmits packets to a TCP/IP microservice along with a context that has been generated based on the contents of the packets. The transmission comprises a request to perform a security service (e.g., TCP/IP reassembly) for the packets to generate reassembled data. The TCP/IP microservice consults the received context to determine whether to obtain a context state, service state, or both, from a state repository to perform the security service. Reassembly is performed by the TCP/IP microservice, any modified state returned to the state repository and the reassembled data transmitted, along with the context, to a DPI microservice as a request to perform DPI processing.

Continuing the example illustrated by FIG. 6, the DPI microservice receives the reassembled data and context from the request to perform DPI security services transmitted by the TCP/IP microservice. The DPI microservice consults the received context to determine whether to obtain a context state, service state, or both, from a state repository to perform its security service. DPI inspection may be performed by the DPI microservice, any modified state returned to the state repository, and a response sent to the TCP/IP microservice.

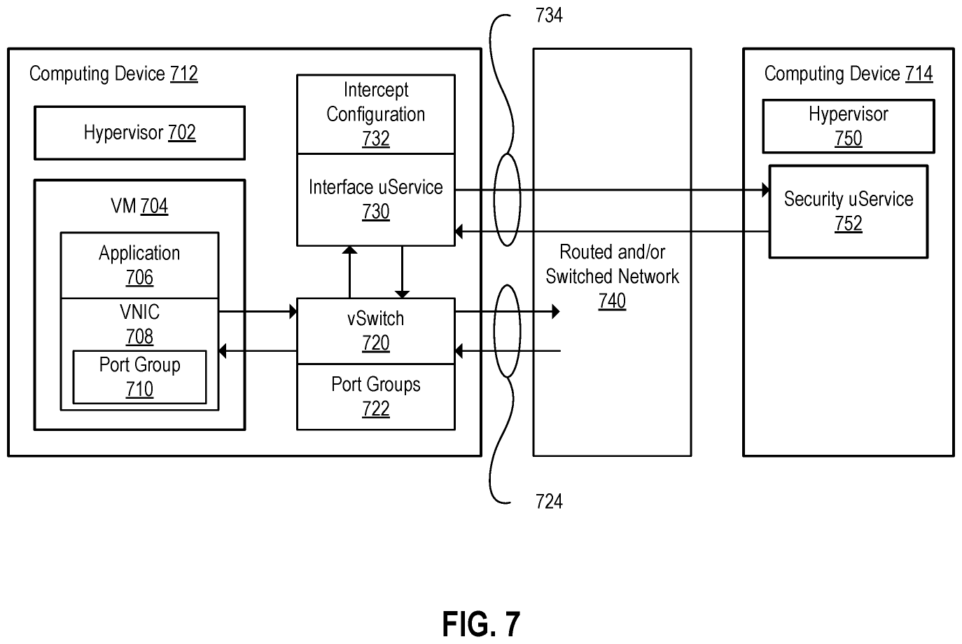

FIG. 7 is a block diagram illustrating an example system for using an interface microservice to intercept network traffic routed by a virtual switch (vSwitch) in accordance with the disclosed embodiments. In an embodiment, the system of FIG. 7 includes at least one computing device 712 coupled to at least one other computing device 714 via a routed and/or switched network 740. The routed and/or switched network 740, for example, might be a network within a data center interconnecting various types of devices within the data center, or any other type of network connecting computing devices 712, 714. Computing devices 712 and 714 include processing hardware and memory, the memory storing software to be executed by the processing hardware. FIG. 7 represents an example embodiment that is provided for purposes of illustrating a clear example; other embodiments may use different arrangements.

In an embodiment, the computing device 712 includes a hypervisor 702, vSwitch 720, and an interface microservice 730. The hypervisor 702 is a component implemented in software, hardware, firmware, or combinations thereof, and which manages the creation and operation of one or more virtual machines (VMs) (e.g., a VM 704). Hypervisors 702 and 750, VM 704, and vSwitch 720 are implemented using software stored in the memory of computing device 712 and/or 714 and executed by the processing hardware. In some embodiments, hypervisor 702 and the VMs it supports/manages (e.g., VM 704) are located on computing device 712. In other embodiments, hypervisor 702 and VM 704 are located on different physical machines or computing devices. In FIG. 7, interface microservice 730 on computing device 712 intercepts network traffic routed by vSwitch 720. In one embodiment, interface microservice 730 can be a single microservice or multiple microservices (e.g., microservices 108-122 from FIG. 1). In some embodiments, vSwitch 720 and port groups 722 are integrated into or otherwise part of hypervisor 702, configured via hypervisor 702, or some combination thereof.

In an embodiment, a VM 704 managed by hypervisor 702 is generally any type of emulated computer system that can share hardware resources with one or more other VMs managed by hypervisor 702. In the example of FIG. 7, a VM includes at least one application 706 and at least one virtual network interface card (VNIC) 708. Examples of an application 706 include, but are not limited to, an operating system, a system application, and a user application.

In an embodiment, a VM 704 is one of a plurality of VMs networked as part of a virtual network. The plurality of VMs can be networked in part using one or more vSwitches (e.g., vSwitch 720). Whereas a physical Ethernet switch manages network traffic between machines on a physical network, a vSwitch manages network traffic between VMs logically connected to virtual ports of the vSwitch. A vSwitch can be connected to other vSwitches and to one or more physical switches (not shown in FIG. 7) using physical Ethernet adapters to join virtual networks with physical networks. For example, the network path 724 might connect the vSwitch 720 to a routed and/or switched network 740 via one or more physical switches.

In an embodiment, a VNIC 708 of a VM 704 is connected to a port of the vSwitch 720, and the port can be assigned to a port group 710. In one embodiment, port group 710 represents a port group identifier or another value indicating a specific port group. At a high level, a port group is a vSwitch configuration which defines a logical grouping of VNICs connected to the ports comprising the group. For example, the system of FIG. 7 can include any number of VMs 704 having any number of VNICs 708, and the VNICs can be grouped into any number of port groups by the vSwitch 720. A port group can be further associated with configuration options applied to the member ports including, for example, bandwidth limitations, traffic shaping rules, and other settings. In an embodiment, a vSwitch 720 stores configuration information related to port groups as port groups configuration 722. For example, when a vSwitch 720 receives a packet from a VNIC 708 of a VM 704, the vSwitch 720 can determine which port group 710 the VNIC 708 is associated with and tag the packet with a VLAN assigned to the port group in the port groups configuration 722.

An interface microservice 730 enables network traffic sent to and received from a VM 704 (and any other VMs generating network traffic routed by vSwitch 720) to be intercepted and filtered based on an intercept configuration 732. As shown in FIG. 7, an interface microservice 730 can optionally send, via network path 734, intercepted network traffic to a security microservice 752 running on a computing device 714. In one embodiment, security microservice 752 can be a single microservice or multiple microservices (e.g., microservices 108-122 from FIG. 1). The computing device 714 includes a separate hypervisor 750 and may further include any number of VMs managed by hypervisor 750 (not shown). In other examples, the interface microservice 730 can perform various security operations locally at a security service at the computing device 712 without sending the intercepted network traffic to security microservice 752.

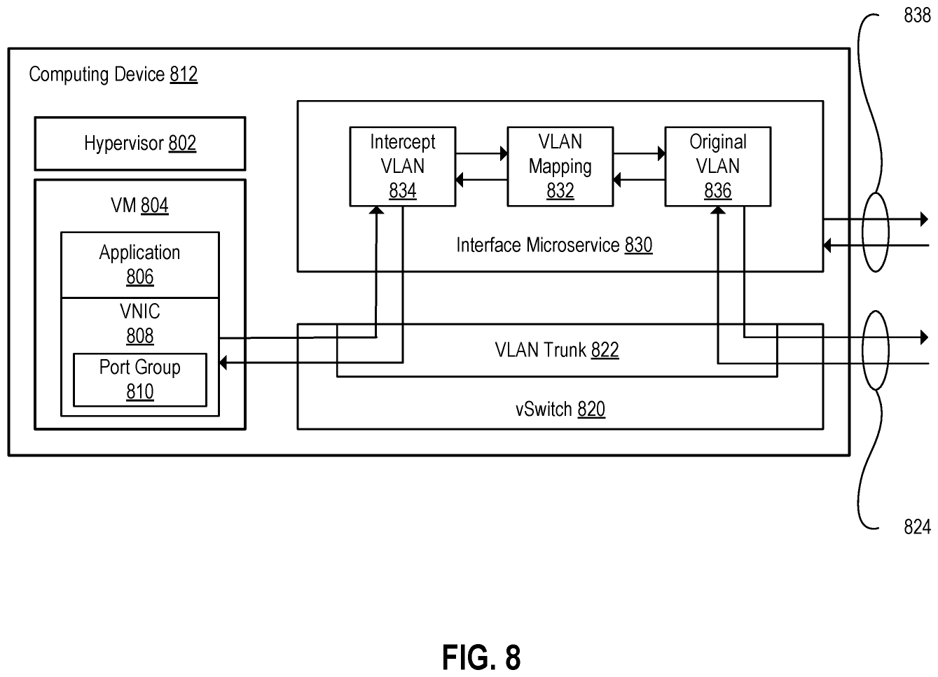

FIG. 8 is a block diagram illustrating an example interface microservice configured to intercept network traffic routed by a vSwitch in accordance with the disclosed embodiments. Interface microservice 830 corresponds to interface microservice 730 of FIG. 7 and vSwitch 820 corresponds to vSwitch 720 of FIG. 7. FIG. 8 includes computing device 812, which includes processing hardware and memory, and where the memory stores software to be executed by the processing hardware. Hypervisors 802, VM 804, and vSwitch 820 are implemented using software stored in the memory of computing device 812 and executed by the processing hardware. In some embodiments, hypervisor 802 and the VMs it supports/manages (e.g., VM 804) are located on computing device 812. In other embodiments, hypervisor 802 and VM 804 are located on different physical machines or computing devices. In FIG. 8, an interface microservice 830 on a computing device 812 intercepts network traffic routed by a vSwitch 820. In one embodiment, interface microservice 830 can be a single microservice or multiple microservices (e.g., microservices 108-122 from FIG. 1).

In one example, interface microservice 830 intercepts network traffic sent and/or received by a VM 804 via a virtual network interface card (VNIC) 808. When the VNIC 808 sends a network packet (e.g., based on a request generated by an application 806 or other source), the VM 804 includes an identifier of the port group 810 with the network packet.

In one embodiment, a VLAN assigned to a port group 810 (e.g., such as in the above example) is referred to as an “original” or “existing” VLAN. In one embodiment, to enable an interface microservice 830 to intercept network traffic routed by the vSwitch 820, the microservice creates a new VLAN, referred to herein as an “intercept” VLAN. The microservice creates an intercept VLAN for each original VLAN, and further generates and stores a VLAN mapping 832 indicating a mapping from each original VLAN to its respective intercept VLAN. The vSwitch 820 also includes a VLAN trunk 822. In one embodiment, the VLAN trunk 822 is a port of vSwitch 820 that facilitates the connection of multiple VLANs to the vSwitch 820 and the passage of network traffic through vSwitch 820. In one embodiment, VLAN trunk 822 serves as a networking trunk in that packets entering the trunk from VLAN 834 are directed to VNIC 808 and packets entering the trunk from VNIC 808 are directed to Intercept VLAN 834 in the same manner as if Intercept VLAN 834 and VNIC 808 were connected point-to-point by an ethernet cable. The interface microservice 830 adds the original VLAN and the intercept VLAN to a VLAN trunk 822 enabling the traffic directed to either the original VLAN or the intercept VLAN to be routed to the interface microservice 830.

In an embodiment, based on the configuration described above, the interface microservice 830 modifies the port group 810 assigned to VM 804 from the port group of the original VLAN (e.g., 836) to the port group of the intercept VLAN (e.g., 834). Consequently, when the vSwitch 820 receives packets sent from VM 804, the vSwitch 820 identifies the port group 810 that the VNIC 808 is assigned to, matches that to the port group of intercept VLAN 834 and directs the packets to the intercept VLAN 834 of the interface microservice 830 via the VLAN trunk 822. The interface microservice 830 can then translate the intercept VLAN 834 to the original VLAN 836 using the VLAN mapping 832, and network traffic leaving network path 824 can be associated with the original VLAN. In one embodiment, the interface microservice 830 sends the packet to a security microservice (e.g., via path 838) for security processing prior to sending the network traffic back to vSwitch 820 for transmission via path 824.

Similarly, when a network packet is received by the vSwitch 820 coming in from the network path 824, because the interface microservice 830 is now part of the VLAN trunk 822 for both the intercept VLAN and the original VLAN and the incoming network packets are associated with the original VLAN, the network packets are routed to the interface microservice 830. The interface microservice 830 similarly maps the original VLAN to the intercept VLAN using the mapping 832, and the packets are sent to the VM 804 using the VLAN trunk 822. In this manner, the changes to the network structure at the hypervisor 802 and vSwitch 820 are transparent to outside devices which only are aware of the original VLAN.

In systems without the interface microservice 830 in FIG. 8, or if the port group identifier for a network packet is associated with an original VLAN without an intercept VLAN in VLAN trunk 822, the vSwitch 820 would receive the network packet including the port group 810 identifier, identify the VLAN (e.g., the original VLAN) and send the network packet out via network path 824 based on the determined original VLAN and destination IP address.

As noted previously, utilizing an interface microservice in the manner described in FIG. 8 can require creating an increasingly larger number of intercept VLANs as the number of original VLANs increases, resulting in the utilization of significant computing and networking resources.

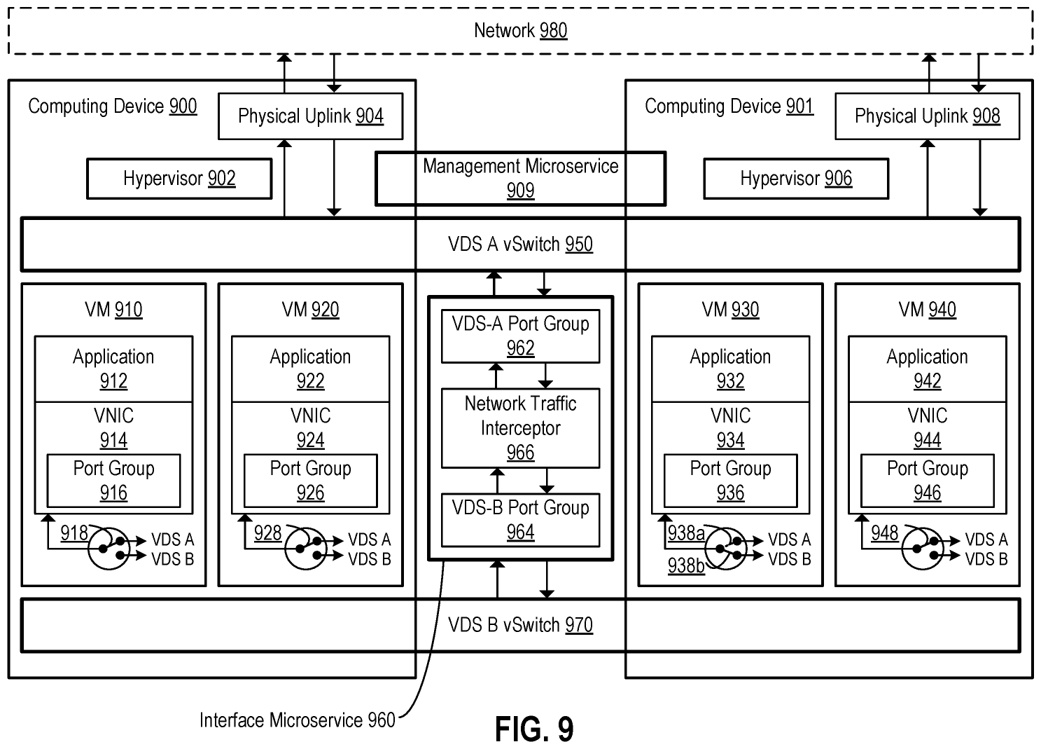

FIG. 9 is a block diagram illustrating an interface microservice configured to intercept network traffic associated with an island virtual switch in accordance with disclosed embodiments. FIG. 9 includes computing devices 900 and 901, management microservice 909, virtual data switch (“VDS”) A vSwitch 950, and VDS B vSwitch 970, and interface microservice 960. In one embodiment, computing device 900 includes hypervisor 902 that creates and manages VMs 910 and 920, and computing device 901 includes hypervisor 906 that creates and manages VMs 930 and 940. Computing devices 901 and 902 include processing hardware and memory. The memory stores software to be executed by the processing hardware. Hypervisors 902 and 906, VMs 910-940, and vSwitches 950 and 970 are implemented using software stored in the memory of computing device 900 and/or 901 and executed by the processing hardware. Although depicted as being located on different computing devices, in some embodiments, hypervisors 902 and 906 and the VMs they support, are located on the same computing device or physical machine.

FIG. 9 also includes physical uplinks 904 and 908 in computing devices 900 and 901, respectively. In one embodiment, physical uplinks 904 and 908 allow VDS A vSwitch 950 to send network traffic (e.g., packets) from VMs 910-940 to a network 980. Examples of network 980 can include an internal routed network (e.g., an intranet) or the internet. As depicted in FIG. 9, VDS B vSwitch 970 does not have a direct access to either physical uplinks 904 and 908. Instead, VDS B vSwitch 970 is connected to interface microservice 960 that acts as an uplink for network traffic to be routed to VDS A vSwitch 950. In one embodiment, VDS B vSwitch 970 can also be referred to as an island virtual switch. Unlike VDS A vSwitch 950, VDS B vSwitch 970 is an island virtual switch because it does not have direct connection to network 980 (e.g., an external network). Instead all network traffic associated with VDS B vSwitch 970 passes through a trunk connection with network traffic interceptor 966. In contrast, VDS A vSwitch 950 does have a direct connection to network 980 via a physical link (e.g., physical uplinks 904 and 908). In one embodiment, VDS A vSwitch 950 has a connection to physical uplinks 904 and 908 via another switch or internal resource. VDS B vSwitch 970 can only interact with interface microservice 960 to send or receive network traffic to or from network 980. As such, resources or VMs located on a port group assigned to VDS B vSwitch 970 (e.g., port group 936) can only send or receive network traffic via VDS B vSwitch 970. For example, because VM 930 is on a port group (e.g., port group 936) that is assigned to VDS B vSwitch 970, VM 930 can only send and receive network traffic through the connection between VDS B vSwitch 970 and interface microservice 960.

In one embodiment, management microservice 909 and interface microservice 960 are software stored in a memory and executed by a processor on computing devices 900 and/or 901, or another computing device. In one embodiment, management microservice 909 and interface microservice 960 are software stored in memory and executed by a processor on a computing device with a hypervisor controlled by the same virtualization control software (e.g. vSphere) as hypervisor 902 or hypervisor 906. In one embodiment, management microservice 909 and interface microservice 960 are examples of microservices 108-122, depicted in FIG. 1. In one embodiment, interface microservice 960 includes VDS-A port group 962 and VDS-B port group 964 that send network traffic through network traffic interceptor 966. VDS-A port group 962 provides an interface to VDS A vSwitch 950, and VDS-B port group 964 provides an interface to VDS A vSwitch 970. In one embodiment, while depicted outside of computing devices 900 and 901, interface microservice 960 is software running or executing on one of computing devices 900 and 901. Similarly, VDS A vSwitch 950 and VDS B vSwitch 970 are software running or executing on one of computing devices 900 and 901.

In one embodiment, each of VMs 910-940 include at least one application 912, 922, 932, 942, respectively. Examples of application 912, 922, 932, 942 include, but are not limited to, an operating system, a system application, and a user application. Each of VMs 910-940 also include a virtual network interface card (VNIC) 914, 924, 934, 944, respectively. Each of VNICs 914, 924, 934, 944 can be assigned to a port group (e.g., port groups 916, 926, 936, and 946, respectively). In one embodiment, the port group represents a port group identifier or another value indicating a specific port group. While in one embodiment, each of port groups 916, 926, and 946 can be an identifier for a different port group, in another embodiment, two or more of port groups 916, 926, and 946 can be assigned to a same port group. In one embodiment, VMs 910-940 include vSwitch indicators 918, 928, 938a/938b, and 948, respectively, to indicate which vSwitch the corresponding VM is assigned to. In one embodiment, vSwitch indicators 918, 928, 938a/938b, and 948 are representations of configurations settings for the corresponding VMs. In some embodiments, the configuration settings are stored in a virtual machine manager (not pictured).

In one embodiment, each of port groups 916, 926, 936, and 946 is mapped to a port group associated with one of VDS A vSwitch 950 and VDS B vSwitch 970. In the example depicted in FIG. 9, vSwitch indicators 918, 928, and 948 indicate VNICs 914, 924, and 944 and the port groups 916, 926, and 946 for VMs 910, 920, and 940, respectively, are pointing to VDS A vSwitch 950. Network traffic to or from VMs 910, 920, and 940 are directed to VDS A vSwitch 950, pass through network traffic interceptor 966 for analysis for potential security operations, and are then passed back to VDS A vSwitch 950 for transmission to network 980 via a physical link (e.g., physical uplinks 904 or 908).

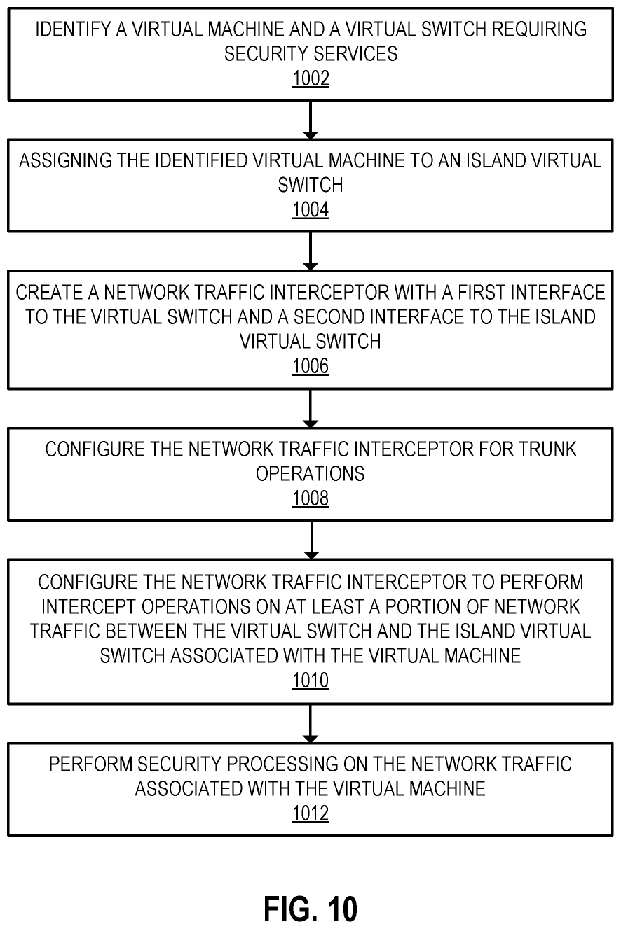

In contrast, vSwitch indicator 938b indicates VNIC 934 and the port group 936 for VM 930 is pointing to VDS B vSwitch 970. As depicted in FIG. 9, VM 930 is assigned to a port group (e.g., port group 936) that is assigned to VDS B vSwitch 970. In some embodiments, hypervisor 906 performs this assignment by launching VM 930 on or moving VM 930 to a port group assigned to VDS B vSwitch 970. In one embodiment, the dashed connection 938a to VDS A indicates that VM 930 was previously assigned to VDS A vSwitch 950. For example, VM 930 may have been switched to VDS B vSwitch 970 via an island virtual switch creation process, as described in FIG. 10.

In one embodiment, when a network packet is sent from a sending VM and directed to a destination, the virtual switch associated with the sending VM determines the virtual switch associated with the destination VM. If the virtual switch associated with the destination VM is the same as the virtual switch associated with the sending VM, the network packet is sent locally. If the virtual switch associated with the destination VM is different from the virtual switch associated with the sending VM, the virtual switch associated with the sending VM directs the network packet to its corresponding virtual switch port group interface. For example, when the application 912 in the VM 910 sends a network packet directed to VM 920 via VNIC 914, hypervisor 902 determines a vSwitch to send the network pack (e.g., based on vSwitch indicator 918, and places the network packet into the memory stack of VDS A vSwitch 950. VDS A vSwitch 950 determines that the destination VM is local (e.g., connected to the same vSwitch) and sends the network packet to VM 920 directly. In embodiments where the destination of the network packet is not local, VDS A vSwitch 950 places the network packet in the memory stack of physical uplink 904 for sending to network 980.

In contrast, hypervisor 906 can handle network packets sent from a VM assigned to VDS B vSwitch 970 differently because the VM is on an island virtual switch. For example, when application 932 in VM 930 sends a network packet directed to VM 910 via VNIC 934, hypervisor 906 determines a vSwitch to send the network pack (e.g., based on vSwitch indicator 938), and places the network packet into the memory stack of VDS B vSwitch 970. If VDS B vSwitch 970 determines that the destination is local, VDS B vSwitch 970 sends the network packet to the local destination. If VDS B vSwitch 970 determines that the destination VM is not local (e.g., connected to a different vSwitch), VDS B vSwitch 970 sends the network packet to VDS-B port group 964. In such embodiments, VDS-B port group 964 operates similarly to a physical link (e.g., physical uplinks 904 and 908). The network packet is then directed to VDS-A port group 962 by the network traffic interceptor 966 (after performing any applicable security processing based on security policies). The interface microservice 960 then sends the network packet to VDS A vSwitch 950, which sends the network packet to VM 910. A similar process occurs when VM 930 sends a network packet that has a destination in network 980, except that VDS A vSwitch 950 determines that the destination is not local to VDS A vSwitch 950 and sends the network packet to network 980 via physical uplink 908.

In one embodiment, network traffic interceptor 966 manages and applies security policies to network traffic received by interface microservice 960 from VDS A vSwitch 950 and VDS B vSwitch 970. In one embodiment, network traffic interceptor 966 receives network traffic, analyzes the network traffic to determines properties of the network traffic (e.g., traffic type, source, destination, etc.), determines a security policy associated with elements of the network traffic based on the determined properties, and performs the determined security policy. In one embodiment, network traffic interceptor 966 performs security policies, including, but not limited to pass-through, intercept, and monitoring. For example, where there is a security policy that says that no security operations should be performed on SSL traffic, when network traffic interceptor 966 receives SSL traffic (e.g., via VDS A vSwitch 950), network traffic interceptor 966 trunks the SSL traffic from VDS-A port group 962 to VDS-B port group 964. In another example, where there is a security policy that says that all HTTP traffic should be intercepted and analyzed, network traffic interceptor 966 captures HTTP traffic received from and/or directed to VDS-A port group 962 and VDS-B port group 964, and instead of trunking the HTTP traffic across to the intended port, network traffic interceptor 966 directs the traffic to a security microservice (not pictured) to perform security operations on the HTTP traffic. When the security microservice completes the security operations, network traffic interceptor 966 may receive the HTTP traffic from the security microservice and direct the HTTP traffic to its intended destination. In another example, interface microservice 960 configures network traffic interceptor 966 to monitor network traffic by copying the network traffic for analysis in the background (e.g., by a security microservice), while trunking the network traffic to its intended destination.

By utilizing an interface microservice in the manner described in FIG. 8, no additional VLANs or IP addresses must be provisioned to provide security services for VMs. Further, configuring and utilizing an island virtual switch in this manner ensures that network traffic associated with VLANs and IP addresses operating within the island environment will not leak into the pre-existing (insecure) environment except as processed and verified by the security service.

FIG. 10 is a flow diagram illustrating a process for creating an island virtual switch for a virtual machine requiring security services in accordance with an embodiment. For ease of understanding, the description of FIG. 10 below references components of the networked environments of FIGS. 1 and 9, however, it is not limited to those components. In one embodiment, a management microservice (e.g., management microservice 909) performs the actions described below. In another embodiment, the management microservice receives instructions to perform the actions described below (e.g., from a security service). In one embodiment, the security service is an example of security service 124, depicted in FIG. 1. Further, in another embodiment, the actions below may be performed by one or more security microservices at the direction of a management microservice. As such, a single security microservice may perform an action, or two more security services may perform the action either independently, or in conjunction. Although FIG. 10 describes operations performed by a management microservice (e.g., microservices 108-122), some or all of the operations described in FIG. 10 can be performed by a configuration microservice, another type of microservice, an application, or any other computer-executable logic.

At block 1002, a management microservice identifies a virtual machine and a virtual switch requiring security services. In one embodiment, the management microservice identifies the virtual machine that requires security services based on the virtual machine having an indicator established by a security administrator. In other embodiments, identification of the virtual machine requiring security services is accomplished by identifying one or more applications executing within the virtual machine, identifying one or more users utilizing applications within the virtual machine, sampling the virtual machine traffic to determine membership in a group or similarity to a group, or by other means. In one embodiment, the management microservice also identifies the port group(s) to which the identified virtual machines are currently assigned. Using the example of FIG. 9, the management microservice identifies VM 930 as requiring security services and identifies that VM 930 is assigned to VDS A vSwitch 950 (as indicated by dashed line 938a).

At block 1004, the management microservice assigns the identified virtual machine to an island virtual switch. In one embodiment, the management microservice creates the island virtual switch through interfacing with the hypervisor control elements, executing a script or automation tool, or by another means. For example, the management microservice creates VDS B vSwitch 970 as an island virtual switch to receive network packets from or directed to VM 930. In one embodiment, VDS B vSwitch 970 is software running or executing on one of computing devices 900 and 901. VDS B vSwitch 970 is an island virtual switch because it does not have direct access to a physical link (e.g., physical uplinks 904 or 908). In other embodiments, the management microservice selects an existing island switch and assigns the identified virtual machine to the existing island virtual switch.

At block 1006, the management microservice creates a network traffic interceptor with a first interface to the virtual switch and a second interface to the island virtual switch. Continuing the example, the management microservice creates network traffic interceptor 966 on interface microservice 960 with a first connection to VDS A vSwitch 950 and a second connection to VDS B vSwitch 970. The second interface between VDS B vSwitch 970 and interface microservice 960 allows VDS B vSwitch 970 to send network traffic to or receive network traffic to from any resources, virtual machines, or entities that are not connected to VDS B vSwitch 970. In contrast, VDS A vSwitch 950, connected to interface microservice 960 via the first interface, has one or more connections to network 980 via physical uplinks 904 and 908.

In one embodiment, to allow interface microservice 960 to communicate with VDS A vSwitch 950 and VDS B vSwitch 970, the management microservice creates VDS-A port group 962 to interface with VDS A vSwitch 950 and VDS-B port group 964 to interface with VDS B vSwitch 970.

At block 1008, the management microservice further configures the network traffic interceptor to operate as a trunk to provide that network traffic can be passed between VDS A vSwitch 950 and VDS B vSwitch 970. In one embodiment, configurating the network interceptor to operate as a trunk includes configuring forwarding rules and/or routing directives for VDS-A Port Group 962 and VDS-B Port Group 964. In one embodiment, configurating the network interceptor to operate as a trunk includes configuring network traffic interceptor 966 to copy some or all of the network traffic between VDS-A Port Group 962 and VDS-B Port Group 964 to another microservice. In one embodiment, configurating network traffic interceptor 966 to operate as a trunk includes configuring network traffic interceptor 966 to intercept some or all of the network traffic between VDS-A Port Group 962 and VDS-B Port Group 964 for proxying by another microservice.

At block 1010, the management microservice configures the network traffic interceptor for intercept operations. In one embodiment, the management microservice configures network traffic interceptor 966 in interface microservice 960 to perform intercept operations on at least a portion of the network traffic sent between VDS A vSwitch 950 and VDS B vSwitch 970. In one embodiment, the management microservice determines whether to perform intercept operations on a portion of the network traffic is based on an analysis of the network, including information regarding the source and/or destination of the network traffic. In one embodiment, network traffic interceptor 966 can perform pass-through, intercept, and monitoring functions.

In one embodiment, the management microservice configures network traffic interceptor 966 to have a connection to VDS A vSwitch 950 and VDS B vSwitch 970.

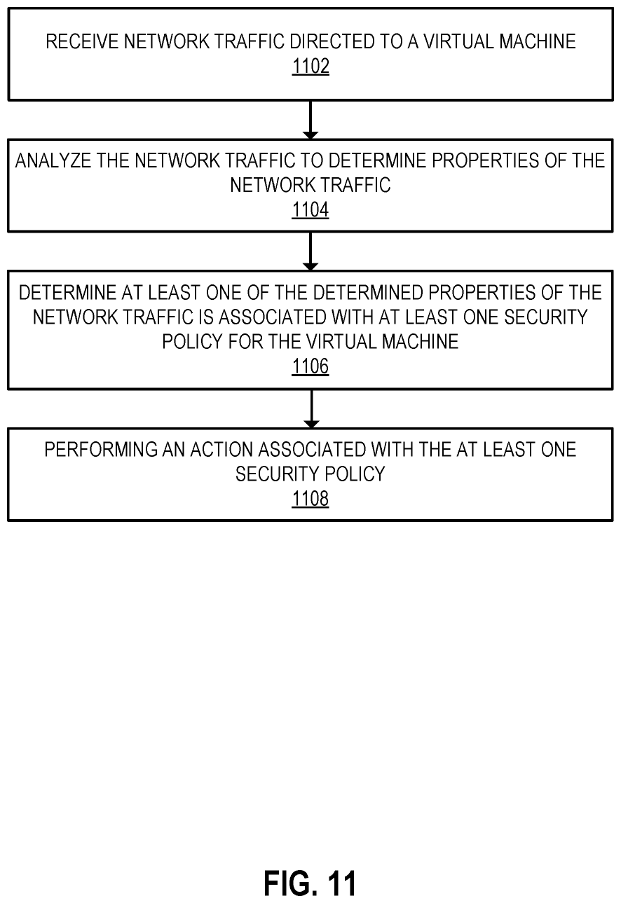

At block 1012, the management microservice performs security processing for the virtual machine. Additional details regarding the security processing are described with respect to FIG. 11.

FIG. 11 is a flow diagram illustrating a process for performing security processing on network traffic between a virtual switch and an island virtual switch in accordance with an embodiment. For ease of understanding, the description of FIG. 11 below references components of the networked environments of FIGS. 1 and 9, however, it is not limited to those components. In one embodiment, a network traffic interceptor performs the actions described below. In another embodiment, the network traffic interceptor receives instructions to perform the actions described below (e.g., from a security service). In one embodiment, the security service is an example of security service 124, depicted in FIG. 1. Further, in another embodiment, the actions below may be performed by one or more security microservices at the direction of a management microservice. As such, a single security microservice may perform an action, or two more security services may perform the action either independently, or in conjunction.

At block 1102, network traffic interceptor 966 receives network traffic directed to a virtual machine. For example, VDS A vSwitch 950 receives network traffic from network 980 (e.g., via physical uplink 904 or 908), where the destination of the network traffic is an application or other resource of VM 930. Because VDS A vSwitch 950 does not have a connection to VM 930 (e.g., VM 930 is mapped to a port group not associated with VDS A vSwitch 950), VDS A vSwitch 950 directs the network traffic to network traffic interceptor 966.

At block 1104, network traffic interceptor 966 analyzes the network traffic to determine properties of the network traffic. In one embodiment, properties of the network traffic include the type of network traffic, the source, the destination, etc.

At block 1106, based on the results of the analysis, network traffic interceptor 966 can identify that at least one of the determined properties of the network traffic is associated with at least one security policy associated with the virtual machine.

At block 1108, in response to determining that at least one of the determined properties of the network traffic is associated with at least one security policy for the virtual machine network traffic interceptor 966 can perform different security operations. In one embodiment, the security operations can include sending the network traffic to a security microservice to perform security processing prior to sending the network traffic to its intended destination or copying the network traffic and performing security processing in parallel or after sending the network traffic to its intended destination. In some embodiments, security operations can include performing TCP reassembly and deep packet inspection.

According to one embodiment, the techniques described herein are implemented by one or more special-purpose computing devices. The special-purpose computing devices may be desktop computer systems, portable computer systems, handheld devices, networking devices or any other device that incorporates hard-wired, program logic, or both to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. Such special-purpose computing devices may also combine custom hard-wired logic, ASICs, or FPGAs with custom programming to accomplish the techniques.

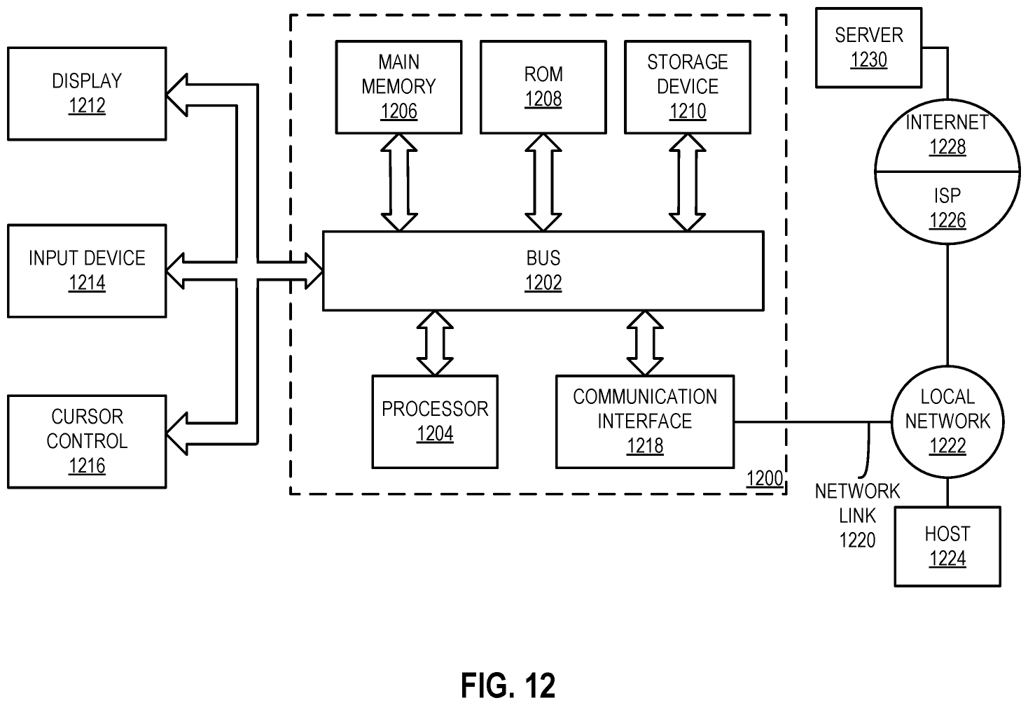

FIG. 12 is a block diagram that illustrates a computer system 1200 utilized in implementing the above-described techniques in accordance with some of the disclosed embodiments. Computer system 1200 may be, for example, a desktop computing device, laptop computing device, tablet, smartphone, server appliance, computing mainframe, multimedia device, handheld device, networking apparatus, or any other suitable device.

Computer system 1200 includes one or more buses 1202 or other communication mechanism for communicating information, and one or more hardware processors 1204 coupled with buses 1202 for processing information. Hardware processors 1204 may be, for example, general purpose microprocessors. Buses 1202 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 1200 also includes a main memory 1206, such as a random-access memory (RAM) or other dynamic or volatile storage device, coupled to bus 1202 for storing information and instructions to be executed by processor 1204. Main memory 1206 also may be used for storing temporary variables or other intermediate information during execution of instructions to be executed by processor 1204. Such instructions, when stored in non-transitory storage media accessible to processor 1204, render computer system 1200 a special-purpose machine that is customized to perform the operations specified in the instructions.

Computer system 1200 further includes one or more read only memories (ROM) 1208 or other static storage devices coupled to bus 1202 for storing static information and instructions for processor 1204. One or more storage devices 1210, such as a solid-state drive (SSD), magnetic disk, optical disk, or other suitable non-volatile storage device, is provided and coupled to bus 1202 for storing information and instructions.

Computer system 1200 may be coupled via bus 1202 to one or more displays 1212 for presenting information to a computer user. For instance, computer system 1200 may be connected via a High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 1212 may include, without limitation, plasma display devices, projectors, cathode ray tube (CRT) monitors, electronic paper, virtual reality headsets, braille terminal, and/or any other suitable device for outputting information to a computer user. In one embodiment, any suitable type of output device, such as, for instance, an audio speaker or printer, may be utilized instead of a display 1212.

One or more input devices 1214 are coupled to bus 1202 for communicating information and command selections to processor 1204. One example of an input device 1214 is a keyboard, including alphanumeric and other keys. Another type of user input device 1214 is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane. Yet other examples of suitable input devices 1214 include a touch-screen panel affixed to a display 1212, cameras, microphones, accelerometers, motion detectors, and/or other sensors. In one embodiment, a network-based input device 1214 may be utilized. In such an embodiment, user input and/or other information or commands may be relayed via routers and/or switches on a Local Area Network (LAN) or other suitable shared network, or via a peer-to-peer network, from the input device 1214 to a network link 1220 on the computer system 1200.

A computer system 1200 may implement techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1210. Volatile media includes dynamic memory, such as main memory 1206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or a solid-state drive of a remote computer. The remote computer can load the instructions into its dynamic memory and use a modem to send the instructions over a network, such as a cable network or cellular network, as modulate signals. A modem local to computer system 1200 can receive the data on the network and demodulate the signal to decode the transmitted instructions. Appropriate circuitry can then place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

A computer system 1200 may also include, in one embodiment, one or more communication interfaces 1218 coupled to bus 1202. A communication interface 1218 provides a data communication coupling, typically two-way, to a network link 1220 that is connected to a local network 1222. For example, a communication interface 1218 may be an integrated services digital network (ISDN) card, cable modem, satellite modem, or a modem to provide a data communication connection to a corresponding type of telephone line. As another example, the one or more communication interfaces 1218 may include a local area network (LAN) card to provide a data communication connection to a compatible LAN. As another example, the one or more communication interfaces 1218 may include a wireless network interface controller, such as an 802.11-based controller, Bluetooth controller, Long Term Evolution (LTE) modem, and/or other types of wireless interfaces. In any such implementation, communication interface 1218 sends and receives electrical, electromagnetic, or optical signals that carry digital data streams representing various types of information.

Network link 1220 typically provides data communication through one or more networks to other data devices. For example, network link 1220 may provide a connection through local network 1222 to a host computer 1224 or to data equipment operated by a Service Provider 1226. Service Provider 1226, which may for example be an Internet Service Provider (ISP), in turn provides data communication services through a wide area network, such as the world-wide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are example forms of transmission media.

In one embodiment, computer system 1200 can send messages and receive data, including program code and/or other types of instructions, through the network(s), network link 1220, and communication interface 1218. In the Internet example, a server 1230 might transmit a requested code for an application program through Internet 1228, ISP 1226, local network 1222 and communication interface 1218. The received code may be executed by processor 1204 as it is received, and/or stored in storage device 1210, or other non-volatile storage for later execution. As another example, information received via a network link 1220 may be interpreted and/or processed by a software component of the computer system 1200, such as a web browser, application, or server, which in turn issues instructions based thereon to a processor 1204, possibly via an operating system and/or other intermediate layers of software components.

In one embodiment, some or all of the systems described herein may be or comprise server computer systems, including one or more computer systems 1200 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In one embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In one embodiment, the cloud-based components may be implemented by third-party entities, on behalf of another entity for whom the components are deployed. In other embodiments, however, the described systems may be implemented entirely by computer systems owned and operated by a single entity.

In one embodiment, an apparatus comprises a processor and is configured to perform any of the foregoing methods. In one embodiment, a non-transitory computer-readable storage medium, storing software instructions, which when executed by one or more processors cause performance of any of the foregoing methods.

Although some embodiments disclosed herein involve data handling and distribution in the context of hardware execution units and logic circuits, other embodiments can be accomplished by way of a data or instructions stored on a non-transitory machine-readable, tangible medium, which, when performed by a machine, cause the machine to perform functions consistent with at least one embodiment. In one embodiment, functions associated with embodiments of the present disclosure are embodied in computer-executable instructions. The instructions can be used to cause a general-purpose or special-purpose hardware processor that is programmed with the instructions to perform the steps of the at least one embodiment. Embodiments of the present invention may be provided as a computer program product or software which may include a machine or computer-readable medium having stored thereon instructions which may be used to program a computer (or other electronic devices) to perform one or more operations according to the at least one embodiment. Alternatively, steps of embodiments may be performed by specific hardware components that contain fixed-function logic for performing the steps, or by any combination of programmed computer components and fixed-function hardware components.

Instructions used to program circuits to perform at least one embodiment can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Examples of embodiments of methods, apparatuses, systems, etc. detailed herein are listed below.

In some embodiments, a computer-implemented method comprises: identifying a virtual machine and a virtual switch requiring security services. The method further comprises assigning the identified virtual machine to an island virtual switch, wherein the island virtual switch does not have a direct connection to a physical link. The method further comprises creating a network traffic interceptor with a first interface to the island virtual switch and a second interface to the virtual switch. The method further comprises configuring the network traffic interceptor to perform intercept operations on at least a portion of network traffic between the virtual switch and the island virtual switch associated with the virtual machine. The method further comprises performing security processing on the at least the portion of the network traffic between the virtual switch and the island virtual switch associated with the virtual machine.

In some embodiments, one or more of the following applies: 1) the method further comprises configuring the network traffic interceptor for trunk operations; 2) the intercept operations include one or more of: monitoring the network traffic, intercepting the network traffic, and passing through the network traffic; 3) performing the security processing on the at least the portion of the network traffic between the virtual switch and the island virtual switch associated with the virtual machine comprises: receiving the network traffic directed to the virtual machine, analyzing the network traffic to determine properties of the network traffic, determining at least one of the determined properties of the network traffic is associated with at least one security policy for the virtual machine, and performing an action associated with the at least one security policy; 4) performing the action associated with the at least one security policy includes directing the at least the portion of the network traffic associated with the virtual machine to a security microservice for security processing; 5) the security processing includes performing one or more of TCP reassembly and deep packet inspection; and 6) the virtual switch has a connection to a physical link.

In some embodiments, one or more non-transitory computer-readable storage media store instructions which, when executed by one or more hardware processors, cause performance of a method comprising: identifying a virtual machine and a virtual switch requiring security services. The method further comprises assigning the identified virtual machine to an island virtual switch, wherein the island virtual switch does not have a direct connection to a physical link. The method further comprises creating a network traffic interceptor with a first interface to the island virtual switch and a second interface to the virtual switch. The method further comprises configuring the network traffic interceptor to perform intercept operations on at least a portion of network traffic between the virtual switch and the island virtual switch associated with the virtual machine. The method further comprises performing security processing on the at least the portion of the network traffic between the virtual switch and the island virtual switch associated with the virtual machine.

In some embodiments, one or more of the following applies: 1) the method further comprises configuring the network traffic interceptor for trunk operations; 2) the intercept operations include one or more of: monitoring the network traffic, intercepting the network traffic, and passing through the network traffic; 3) performing the security processing on the at least the portion of the network traffic between the virtual switch and the island virtual switch associated with the virtual machine comprises: receiving the network traffic directed to the virtual machine, analyzing the network traffic to determine properties of the network traffic, determining at least one of the determined properties of the network traffic is associated with at least one security policy for the virtual machine, and performing an action associated with the at least one security policy; 4) performing the action associated with the at least one security policy includes directing the at least the portion of the network traffic associated with the virtual machine to a security microservice for security processing; 5) the security processing includes performing one or more of TCP reassembly and deep packet inspection; and 6) the virtual switch has a connection to a physical link.

In some embodiments, an apparatus comprises: one or more hardware processors; and memory coupled to the one or more hardware processors, the memory storing instructions which, when executed by the one or more hardware processors, cause the apparatus to: identify a virtual machine and a virtual switch requiring security services. The instructions further cause the apparatus to assign the identified virtual machine to an island virtual switch, wherein the island virtual switch does not have a direct connection to a physical link. The instructions further cause the apparatus to create a network traffic interceptor with a first interface to the island virtual switch and a second interface to the virtual switch. The instructions further cause the apparatus to configure the network traffic interceptor to perform intercept operations on at least a portion of network traffic between the virtual switch and the island virtual switch associated with the virtual machine. The instructions further cause the apparatus to perform security processing on the at least the portion of the network traffic between the virtual switch and the island virtual switch associated with the virtual machine.

In some embodiments, one or more of the following applies: 1) the instructions further cause the apparatus to configure the network traffic interceptor for trunk operations; 2) the intercept operations include one or more of: monitoring the network traffic, intercepting the network traffic, and passing through the network traffic; 3) performing the security processing on the at least the portion of the network traffic between the virtual switch and the island virtual switch associated with the virtual machine further causes the apparatus to: receive the network traffic directed to the virtual machine, analyze the network traffic to determine properties of the network traffic, determine at least one of the determined properties of the network traffic is associated with at least one security policy for the virtual machine, and perform an action associated with the at least one security policy; 4) performing the action associated with the at least one security policy includes directing the at least the portion of the network traffic associated with the virtual machine to a security microservice for security processing; 5) the security processing includes performing one or more of TCP reassembly and deep packet inspection; and 6) the virtual switch has a connection to a physical link.

What is claimed is:

1. A computer-implemented method comprising:
identifying a virtual machine and a virtual switch requiring security services;
assigning the identified virtual machine to an island virtual switch,
wherein the island virtual switch does not have a direct connection to a physical link;
creating a network traffic interceptor with a first interface to the island virtual switch and a second interface to the virtual switch;
configuring the network traffic interceptor to perform intercept operations on at least a portion of network traffic between the virtual switch and the island virtual switch associated with the virtual machine; and
performing security processing on the at least the portion of the network traffic between the virtual switch and the island virtual switch associated with the virtual machine.

2. The computer-implemented method of claim 1, further comprising:
configuring the network traffic interceptor for trunk operations.

3. The computer-implemented method of claim 2, wherein the intercept operations include one or more of: monitoring the network traffic, intercepting the network traffic, and passing through the network traffic.

4. The computer-implemented method of claim 1, wherein performing the security processing on the at least the portion of the network traffic between the virtual switch and the island virtual switch associated with the virtual machine comprises:
receiving the network traffic directed to the virtual machine;
analyzing the network traffic to determine properties of the network traffic;
determining at least one of the determined properties of the network traffic is associated with at least one security policy for the virtual machine; and
performing an action associated with the at least one security policy.

5. The computer-implemented method of claim 4, wherein performing the action associated with the at least one security policy includes directing the at least the portion of the network traffic associated with the virtual machine to a security microservice for security processing.

6. The computer-implemented method of claim 5, wherein the security processing includes performing one or more of TCP reassembly and deep packet inspection.

7. The computer-implemented method of claim 1, wherein the virtual switch has a direct connection to the physical link.

8. One or more non-transitory computer-readable storage media storing instructions which, when executed by one or more hardware processors, cause performance of a method comprising:
identifying a virtual machine and a virtual switch requiring security services;
assigning the identified virtual machine to an island virtual switch, wherein the island virtual switch does not have a direct connection to a physical link;
creating a network traffic interceptor with a first interface to the island virtual switch and a second interface to the virtual switch;
configuring the network traffic interceptor to perform intercept operations on at least a portion of network traffic between the virtual switch and the island virtual switch associated with the virtual machine; and
performing security processing on the at least the portion of the network traffic between the virtual switch and the island virtual switch associated with the virtual machine.

9. The non-transitory computer-readable storage media of claim 8, further comprising:
configuring the network traffic interceptor for trunk operations.

10. The non-transitory computer-readable storage media of claim 9, wherein the intercept operations include one or more of: monitoring the network traffic, intercepting the network traffic, and passing through the network traffic.

11. The non-transitory computer-readable storage media of claim 8, wherein performing the security processing on the at least the portion of the network traffic between the virtual switch and the island virtual switch associated with the virtual machine comprises:
receiving the network traffic directed to the virtual machine;
analyzing the network traffic to determine properties of the network traffic;
determining at least one of the determined properties of the network traffic is associated with at least one security policy for the virtual machine; and
performing an action associated with the at least one security policy.

12. The non-transitory computer-readable storage media of claim 11, wherein performing the action associated with the at least one security policy includes directing the at least the portion of the network traffic associated with the virtual machine to a security microservice for security processing.

13. The non-transitory computer-readable storage media of claim 12, wherein the security processing includes performing one or more of TCP reassembly and deep packet inspection.

14. The non-transitory computer-readable storage media of claim 8, wherein the virtual switch has a connection to a physical link.

15. An apparatus comprising:
one or more hardware processors;
memory coupled to the one or more hardware processors, the memory storing instructions which, when executed by the one or more hardware processors, causes the apparatus to:
identify a virtual machine and a virtual switch requiring security services;
assign the identified virtual machine to an island virtual switch, wherein the island virtual switch does not have a direct connection to a physical link;
create a network traffic interceptor with a first interface to the island virtual switch and a second interface to the virtual switch;
configure the network traffic interceptor to perform intercept operations on at least a portion of network traffic between the virtual switch and the island virtual switch associated with the virtual machine; and
perform security processing on the at least the portion of the network traffic between the virtual switch and the island virtual switch associated with the virtual machine.

16. The apparatus of claim 15, wherein the instructions further cause the apparatus to:
configure the network traffic interceptor for trunk operations.

17. The apparatus of claim 16, wherein the intercept operations include one or more of: monitoring the network traffic, intercepting the network traffic, and passing through the network traffic.

18. The apparatus of claim 15, wherein performing the security processing on the at least the portion of the network traffic between the virtual switch and the island virtual switch associated with the virtual machine further causes the apparatus to:
receive the network traffic directed to the virtual machine;
analyze the network traffic to determine properties of the network traffic;
determine at least one of the determined properties of the network traffic is associated with at least one security policy for the virtual machine; and
perform an action associated with the at least one security policy.

19. The apparatus of claim 18, wherein performing the action associated with the at least one security policy includes directing the at least the portion of the network traffic associated with the virtual machine to a security microservice for security processing.

20. The apparatus of claim 19, wherein the security processing includes performing one or more of TCP reassembly and deep packet inspection.

21. The apparatus of claim 15, wherein the virtual switch has a connection to a physical link.
